(19) United States
(12) Patent Application Publication
(10) Pub. No.: US 2013/0238642 A1
(43) Pub. Date: Sep. 12, 2013

(54) Systems and Methods for Data Integration and Standardization

(71) Applicants: Timothy B. Clayton, Cary, NC (US); Mark Gorton, Wake Forest, NC (US); Thomas Grundstrom, Cary, NC (US); Ankur Jain, Cary, NC (US)

(72) Inventors: Timothy B. Clayton, Cary, NC (US); Mark Gorton, Wake Forest, NC (US); Thomas Grundstrom, Cary, NC (US); Ankur Jain, Cary, NC (US)

(73) Assignee: Quintiles Transnational Corp., Durham, NC (US)

(21) Appl. No.: 13/607,100

(22) Filed: Sep. 7, 2012

Related U.S. Application Data
(60) Provisional application No. 61/532,952, filed on Sep. 9, 2011.

(51) Int. Cl. G06F 17/30

(52) U.S. Cl. CPC G06F 17/30569
USPC 707/756

(57) ABSTRACT

Systems and methods for data integration and standardization are disclosed. For example, one disclosed method comprises receiving first and second clinical trial data from first and second data stores, transforming the first clinical trial data and the second clinical trial data into operational data formats and storing the transformed data in a second operational data store; generating a first data entity stored in an integrated data format in an integrated data store; selecting a first data record from first clinical trial data in the first operational data format; identifying a second data record from the second clinical trial data in the second operational data format, wherein identifying the second data record is based at least in part on a determined association between the first data record and the second data record; and storing data from the first data record and the second data record in the first data entity.

### CROSS-REFERENCES TO RELATED APPLICATION

This application claims priority to U.S. Provisional Patent Application No. 61/532,952 filed Sep. 9, 2011, entitled “Systems and Methods for Data Integration and Standardization,” the entirety of which is hereby incorporated by reference.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### FIELD

The present disclosure relates generally to data integration and more specifically relates to data integration for clinical trials.

### BACKGROUND

In a clinical trial, it is common for a clinical research organization (“CRO”) to receive large quantities of clinical trial data from a multitude of different sources. In the past, a common procedure was to store data over the course of a trial at the various data provider locations and to provide the clinical trial data to the CRO all at once or perhaps in large batches two or three times during the course of the trial, which could last several years. When the data is received by the CRO, the CRO often must ingest the data into a database system for analysis. However, a single trial may occur at a large number of different locations, each of which may store portions of its data in several different data stores. Each of these locations may store its trial data differently in each of its different systems and, typically, does not relate data records from these different systems that are all associated with a particular event, such as a subject's office visit. Thus, the CRO will typically receive a large quantity of database records, stored in different formats, which may relate to common events but have no explicit relation within the various data stores.

For example, during an office visit, a subject may have data recorded about him for a variety of purposes. During intake, a investigator may weigh the subject, measure his height, and check his blood pressure and pulse. This intake data may be stored in one system. Then, after intake, the subject may have a blood sample drawn for testing, the results of which may be stored in a second system. The investigator perform an ECG on the subject and record the ECG data, which is then stored in a third system. Further, each of these systems may store their respective data in different ways. For example, the first system may refer to an office visit by date, the second system may refer to the office visit based on the number of days since the beginning of the trial, and the third system may refer to the office visit based on the total number of office visits to date (e.g. Visit #3). As a result, while all three systems hold some of the data for the office visit, it can be difficult to align the different data records such that a complete record of the visit may be aggregated by the CRO.

In addition, because each data service provider and each system at each data service provider may store the same data in different ways, it can be difficult to align data records having the same type of information. Thus, in the conventional CRO data ingestion process, software programmers often must analyze the definitions of data records from each of the disparate systems used at each of the data providers or within different studies served by the same CRO, and generate custom software to receive the multitude of different records and properly correlate the data from the various records such that they may be stored in the CRO's database in common format and in the correct data field. Further, because this process must often be performed anew for every clinical trial, as data records and formats change from trial to trial, it can be a very expensive, burdensome, and slow process to ingest all of the data from a clinical trial.

### SUMMARY

The present disclosure describes embodiments of systems and methods for data integration and standardization. For example, one disclosed method includes receiving first clinical trial data from a first data store, the first clinical trial data stored in a first format and comprising a plurality of data records; receiving second clinical trial data from a second data store, the second data store different from the first data store, the second clinical trial data stored in a second format, the second format different from the first format and comprising a plurality of data records; transforming the first clinical trial data from the first format to a first operational data format and storing the first clinical trial data in the first operational data format in a first operational data store; transforming the second clinical trial data from the second format to a second operational data format and storing the second clinical trial data in the second operational data format in a second operational data store; generating a first data entity stored in an integrated data format in an integrated data store; selecting a first data record from first clinical trial data in the first operational data format; identifying a second data record from the second clinical trial data in the second operational data format, wherein identifying the second data record is based at least in part on a determined association between the first data record and the second data record; and storing data from the first data record and the second data record in the first data entity. In another embodiment, a computer-readable medium comprises program code for causing one or more processors to execute such a method.

These illustrative embodiments are mentioned not to limit or define the disclosure, but rather to provide examples to aid understanding thereof. Illustrative embodiments are discussed in the Detailed Description, which provides further description of the disclosure. Advantages offered by various embodiments of this disclosure may be further understood by examining this specification.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

FIGS. 1-3B show systems for data integration and standardization according to embodiments;

FIGS. 4-5 show a methods for data integration and standardization according to one embodiment; and

FIG. 6 shows a system for data integration and standardization according to one embodiment.

### DETAILED DESCRIPTION

Example embodiments are described herein in the context of systems and methods for data integration and standardization. Those of ordinary skill in the art will realize that the following description is illustrative only and is not intended to be in any way limiting. Other embodiments will readily suggest themselves to such skilled persons having the benefit of this disclosure. Reference will now be made in detail to implementations of example embodiments as illustrated in the accompanying drawings. The same reference indicators will be used throughout the drawings and the following description to refer to the same or like items.

### Illustrative Method for Product Purchase and Registration

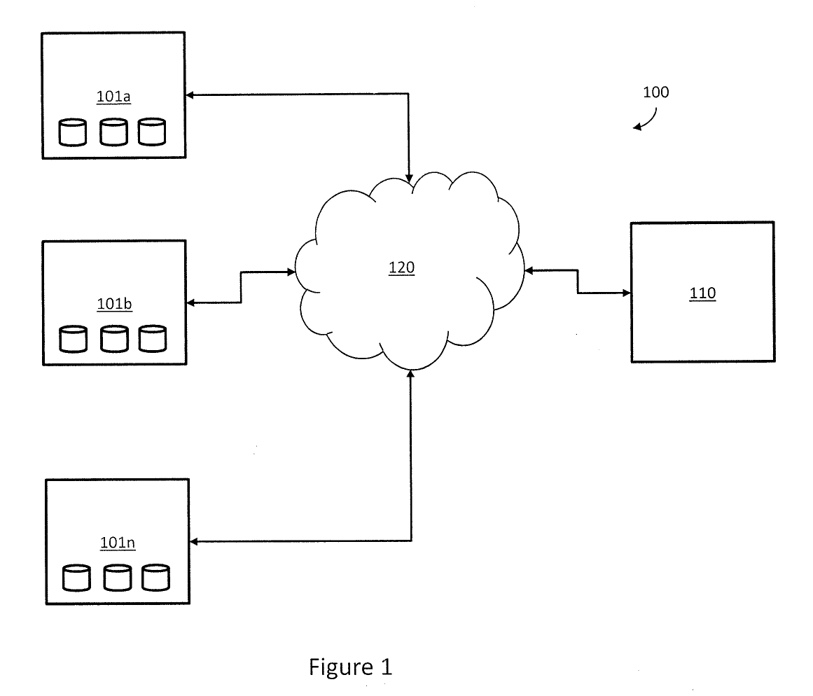

Referring now to FIG. 1, FIG. 1 shows an illustrative embodiment of a system for data integration and standardization according to this disclosure. In the embodiment shown in FIG. 1, a number of remote sites participate in a clinical trial or multiple clinical trials served by a single CRO. During the clinical trial, the various sites obtain data relevant to the trial and store the data at various data service providers 101a-n for later submission to a CRO 110 over a network connection through network 120. Each data service provider 101a-n subsequently sends accumulated trial data from its data stores to the CRO 110 for processing. The CRO 110 receives data from the different data providers 101a-n in real time and stores the data in a data store. However, because each of the different data service providers 101a-n store their respective data in different formats and according to different conventions, the CRO 110 then transforms the data received from the various data providers and systems into a set of data structures having a common format. Some of the data within these common data structures frequently represents data related to the same entity within a particular clinical study.

For example, a subject may have data stored in a number of different data structures, such as for various visits to a clinical trial site. Thus, it may be advantageous to create a data entity representative of data about the subject such that a single data entity comprises (or refers to) all of the data associated with the entity, rather than maintaining a set of disparate data records. Thus, the CRO then creates or updates one or more data entities in an integrated data store, where each of the data entities comprises the data (or references to other data) associated with the respective data entity. In some cases, references to data may be used instead of copies of the actual data. For example, in this illustrative embodiment, the integrated data store comprises data entities representing subjects and visits. A subject may be associated with multiple visits, but because visits are stored as separate entities, the subject entity comprises references to visit entities associated with the subject in addition to data specific to the subject, such as an ID number, a gender, an age, etc.

Those of ordinary skill in the art will realize that this disclosure is illustrative only and is not intended to be in any way limiting. Other embodiments will readily suggest themselves to such skilled persons having the benefit of this disclosure.

In the interest of clarity, not all of the routine features of the implementations described herein are shown and described. It will, of course, be appreciated that in the development of any such actual implementation, numerous implementation-specific decisions often must be made to achieve the developer's specific goals, such as compliance with application- and business-related constraints, or to adhere to regulatory mandates and guidance, and that these specific goals will vary from one implementation to another and from one developer to another.

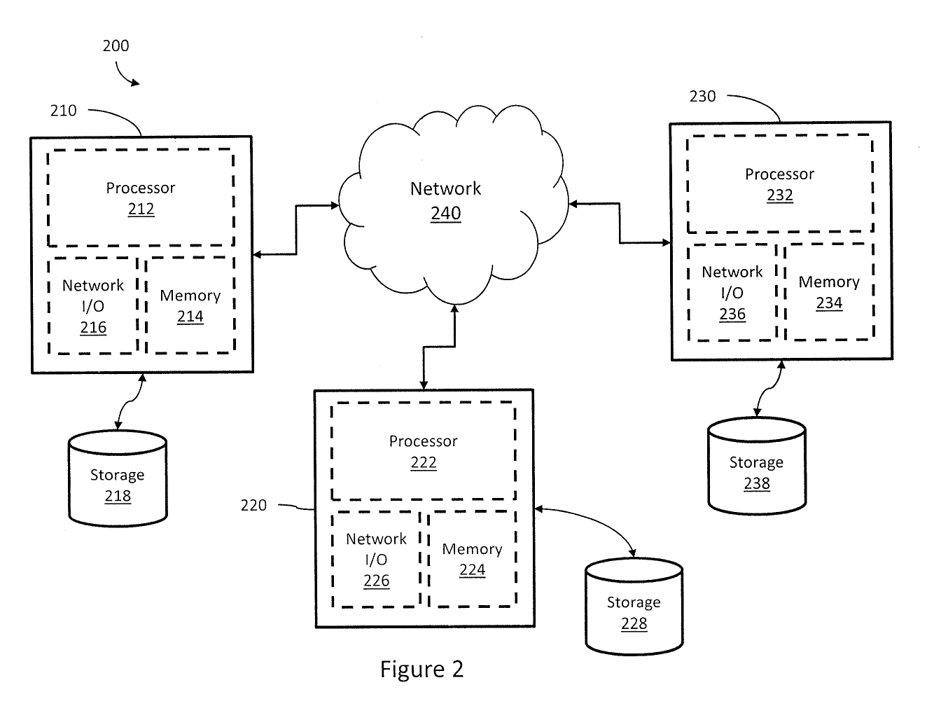

Referring now to FIG. 2, FIG. 2 shows a system 200 for data integration and standardization according to one embodiment. In the embodiment shown, the system 200 comprises three processing devices 210-230, each of which is communication with data storage 218-238. In addition, each of the processing devices 210-230 is in communication with a network 240 for the transmission and reception of data. In the embodiment shown, each of the processing devices 210-230 comprises at least one processor 212-232, at least one memory 214-234, and at least one network interface 216-236. While each of the processing devices 210-230 comprises similar components, the processing devices 210-230 may each be configured as appropriate according to various embodiments. For example, in one embodiment, processing device 210 is configured to handle small amounts of processing and data and thus comprises less memory and fewer processors or processor cores, while processing device 230 comprises a plurality of server computers. For example, in one embodiment, a processing device 210-230 may comprise a plurality of physical or virtual processing devices, such as individual computers or multiple instances of software executing on one or more virtual servers.

Within the processing devices 210-230, the respective processor 212-232 is in communication with the memory 214-234 and the network interface 216-236. The processor 212-232 is configured to execute program code stored in memory 214-234 and to carry out instructions based on the program code. In addition, the processor 212-232 is configured to communicate with the network interface 216-236 to transmit and receive data over the network 240.

As may be seen in FIG. 2, each processing device 210-230 is in communication with a storage device 218-238. In the embodiment shown in FIG. 2, the storage devices 218-238 comprises database management systems (each a “DBMS”) executed on a separate computer or computers. Though in some embodiments, a DBMS may be resident and executed on a processing device 210-230. In some embodiments, the processing device 210-230 is in communication with the storage device 218-238 over a network that is different from network 240, or one or more of the storage devices 218-238 may be in communication with network 240. Each of the storage devices 218-238 is configured to receive and store data and the provide data in response to data requests, such as data requests from a processing device 210-230. Suitable storage devices include hard disks, optical disks, storage area networks (SANs). In embodiments employing a DBMS, various suitable DBMSes may be used, such as a relational DBMS, an object-oriented DBMS, a transactional DBMS (such as may be executed by a mainframe computer), or other suitable DBMSes that may be available.

In the embodiment shown in FIG. 2, each processing device 210-230 is configured to receive and transform or store data received from another data source. The first processing device 210 is configured to receive one or more data feeds from one or more data service providers and to store data received from such data feeds in the first storage device 218. Thus, during operation, as clinical trial sites generate data and submit that data to the respective data service providers, those data records may be transmitted to the first processing device 210 for ingestion into the system for data integration and standardization according to this embodiment. The first processing device 210 receives data from the data feeds and generates one or more commands to store the received data into the storage device 218.

In this embodiment, the second processing device 220 is configured to retrieve data from the first processing device 210 and to generate one or more data records in a common data format based on the data received from the first processing device 210. For example, data stored by the first processing device 210 in the first data storage device 218 may be stored in a plurality of different formats according to the formats used by the one or more data service providers. The second processing device 220 comprises program code having instructions relating to transformations that may be performed to extract data from the plurality of different formats received from the first processing device 210 and to store the extracted data in data records having a common format in the second data storage device 228.

The third processing device 230, in the embodiment shown in FIG. 2, is configured to receive data from the second storage device 228 and to generate one or more data entities to be stored in the third storage device 238. For example, in one embodiment, the third processing device 230 is configured to request data from the second storage device and to receive one or more data records in response to the request. The third processing device 230 is further configured to identify one or more entities related to the received data records. For example, a data record received from the second storage device 228 may comprise data related to a subject visit and thus may be related to a visit entity and a subject entity. If a corresponding entity exists, the third processing device may generate one or more signals to be transmitted to the third storage device 238 to cause the respective data entity (or entities) to be updated with the data from the received data record. If one or more corresponding entities does not exists, the third processing device 230 may generate one or more signals to be transmitted to the third storage device 238 to cause one or more new data entities to be generated to store at least some of the data from the received data record. The third storage device may further generate and transmit a signal to cause one or more data entities to be updated in the third data storage device 238 to indicate a relationship between the two data entities.

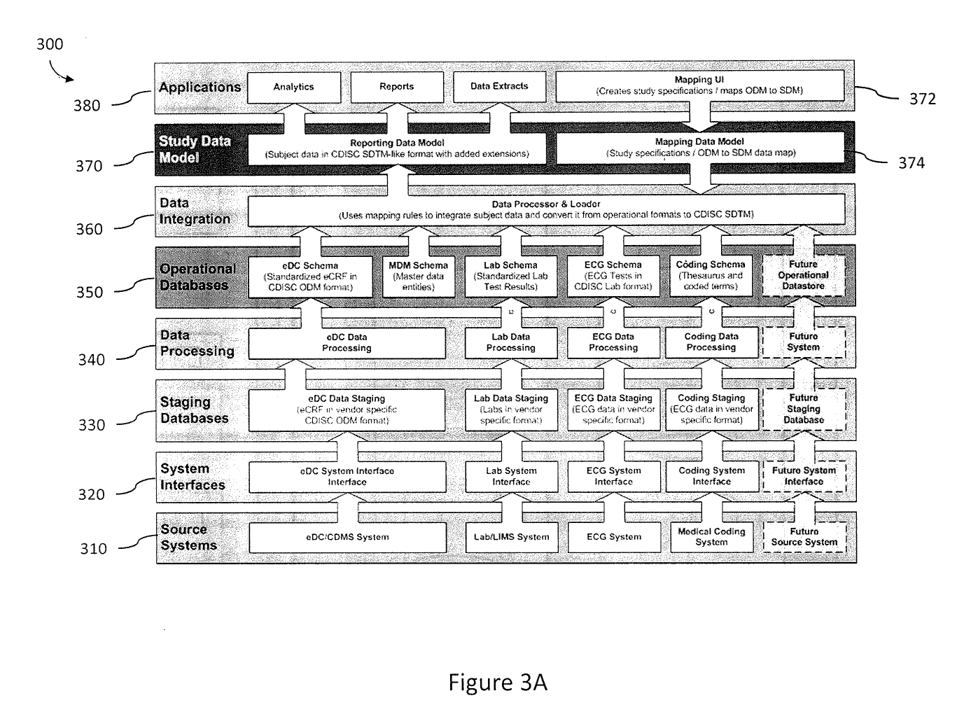

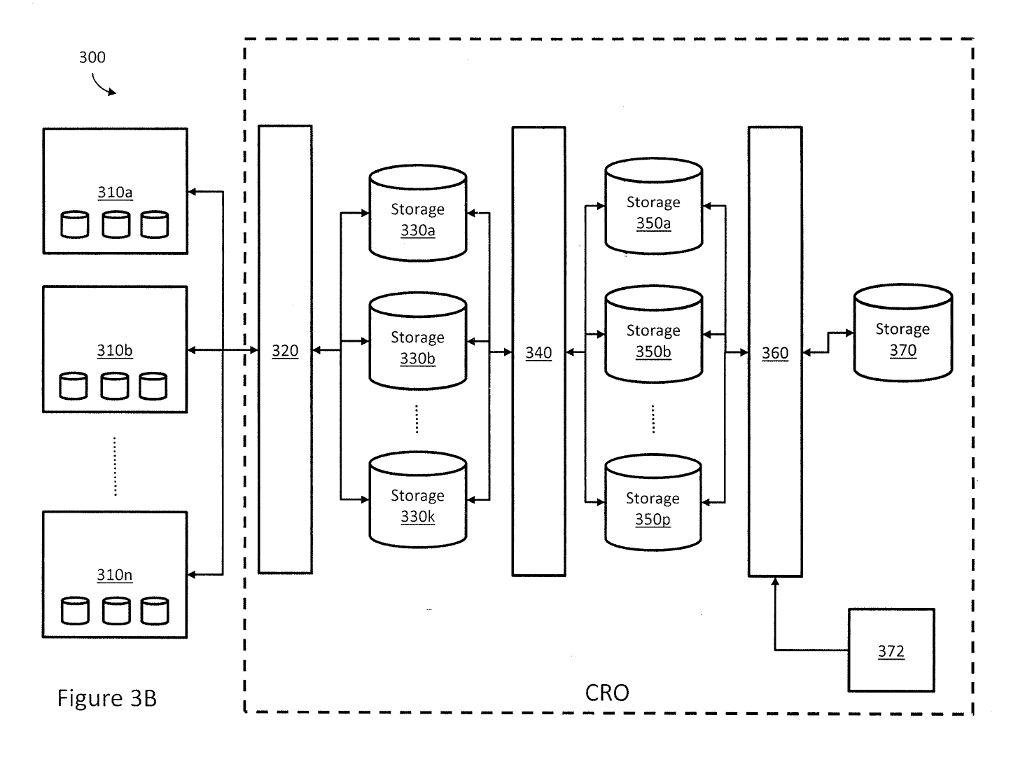

Referring now to FIGS. 3A-B, FIGS. 3A-B shows an embodiments of systems for data integration and standardization according to embodiments. The system 300 shown in FIGS. 3A-B comprises a plurality of system interfaces 320 that are in communication with a plurality of data source systems 310a-n, a plurality of staging databases 330a-k, a data processing layer 340, a plurality of operational databases 350a-p, a data integration layer 360, a CRO integrated data store or study data model 370 in communication with a plurality of analytics applications 380, and a mapping tool 372.

In this illustrative system 300, the system interfaces 320 comprise executable program code (such as web services for receiving data) and are in communication with one or more source systems 310a-n and the staging databases 330a-k. Note that the letters used to denote different components of the same type in FIG. 3 (e.g. 310n, 330k, etc.) are used simply to represent an arbitrary number of similar components. Different final letters have been used simply to indicate that the number of each type of component may vary and need not be the same as other types of components. The system interfaces 320 are configured to receive data from the source systems 310a-n and to store the received data in the staging databases 330. In one embodiment, the system interfaces 320 are configured to receive data from source systems on a periodic bases, such as daily, or in real time, or near-real time. The use of the term “real time” throughout this specification refers to data received relatively shortly after it has been collected, such as within minutes, hours, or days of collection and storage within a data source (e.g. data sources 310a-n), in contrast to traditional systems in which data is received after a study completes or one or two interim data retrievals during the course of a study. For example, in one embodiment, each system interface is configured to request data from a corresponding source system (or systems) daily.

As may be seen in FIGS. 3A-B, each system interface is configured to receive data from one source system, though in some embodiments, a particular system interface may be configured to receive data from a plurality of source systems or provide data to a plurality of staging databases. The data received from the source systems 310a-n may be in a particular format, such as a vendor-specific format or an industry-standard format. As is understood in the art, each supplier of data may employ a different system for collecting and storing data prior to providing it to a CRO. Thus, the different system interfaces 320 are configured to receive data in the format associated with each respective corresponding source system(s) and to store the data in the staging databases 330a-k according to the particular format used by the respective source system.

The staging databases 330a-k comprise one or more conventional database systems executed on one or more server computers and are in communication with the system interfaces, as described above, and with the data processing layer, and are configured to receive and store data from the system interfaces 320 and to provide data to the data processing layer 340 in response to receiving requests for data. The staging databases 330a-k in this illustrative example comprise relational databases configured to receive and respond to SQL commands; however, in some embodiments, the staging databases may comprise other types of databases, such as object-oriented databases or transactional databases (e.g. a TPF mainframe system). Each of the staging databases is configured to store the data according to the vendor-specific format of the system from which the data was received.

The data processing layer 340 of the system shown in FIG. 1 is in communication with the staging databases 330a-k and is configured to provide data to the operational databases 350a-p. The embodiment of the data processing layer 340 in the system 300 shown comprises program code configured to be executed by a processor to retrieve data from the staging databases 330a-k and to transform the data from the staging database format into a standardized data format, such as a standardized CDISC ODM format in use by the CRO.

The operational databases 350a-p in the system shown in FIG. 3 comprise conventional database systems executed on one or more server computers and are in communication with the data processing layer 340 and the data integration layer 360, and are configured to receive and store data from the data processing layer 340 and to provide data to the data integration layer 360 in response to receiving requests for data. The operational databases 350a-p in this illustrative example comprise relational databases configured to receive and respond to SQL commands; however, in some embodiments, the operational databases 350a-p may comprise other types of databases, such as object-oriented databases or transactional databases. Each of the operational databases 350a-p is configured to receive and store data in a common format.

The embodiment of the data integration layer 360 in the system shown in FIG. 3 comprises executable program code executed by one or more processors and is in communication with the operational databases 350a-p and with the CRO integrated data store 370, and is configured to retrieve data from the operational databases and to integrate the data to associate data records for common entities and to store the integrated data in the CRO data store. The data integration layer 360 is also configured to retrieve a mapping schema 374 from the mapping tool 372 and to execute a data standardization processes according to the mapping schema 374.

In this illustrative embodiment, the data integration layer 360 is configured to retrieve a plurality of data records from the operational databases 350a-p, identify data records associated with a particular entity, determine a master record for the entity, and to associate each of the other identified data records with the master record for the entity. The data integration layer 360 is further configured to analyze data from a master record for the entity and from an associated record for the entity and to generate an exception if a data discrepancy is determined. The data integration layer 360 is further configured to receive data to resolve the identified discrepancy and to update the master record or the associated record with a corrected data value.

The data integration layer 360 within the embodiment shown in FIG. 3 is also configured to perform data standardization for at least some of the data received from the operational databases 350a-p based at least in part on the mapping schema 374. For example, in one embodiment, the data integration layer 360 may receive a mapping schema 374 represented by an Excel spreadsheet. The data integration layer 360 may then retrieve data from the operational databases 350a-p and, based at least in part on the mapping schema 374, it may retrieve data corresponding to office visit entities and map the data to corresponding data fields in a database record within the CRO integrated data store 370. In this embodiment, the data integration layer 360 is configured such that, if a data field within the CRO integrated data store or within the operational database is changed, a new mapping schema 374 may be generated and used without the need to modify software executing within the data integration layer 360.

The CRO integrated data store 370 comprises one or more conventional database systems executed on one or more server computers and is in communication with the data integration layer 360 and is configured to receive one or more mapping schemas 374 from a mapping tool 372. The CRO integrated data store 370 is also configured to receive integrated data from the data integration layer 360. In some embodiments, the CRO integrated data store 370 may also be in communication with one or more applications 380, such as analytics applications for monitoring progress of a clinical trial. In one such embodiment, the CRO integrated data store is configured to receive a data request from one application and to provide data to the application in response to the data request.

The CRO integrated data store 370 in this illustrative example comprises a relational database configured to receive and respond to SQL commands; however, in some embodiments, the CRO integrated data store may comprise other types of databases, such as object-oriented databases or transactional databases.

The mapping tool 372 of the system shown in FIG. 3 comprises executable program code executed by one or more processors and is in communication with the CRO integrated data store 370 and the data integration layer 360. The mapping tool 372 is configured to receive data describing data fields within the CRO integrated data store 370 and data describing forms specified within the clinical trial and to generate one or more mapping schemas 374 based on the CRO integrated data store and the form specifications. The mapping tool 372 is further configured to store the mapping schema(s) 374 within the CRO integrated data store, or to provide the mapping schema(s) 374 to the data integration layer 372.

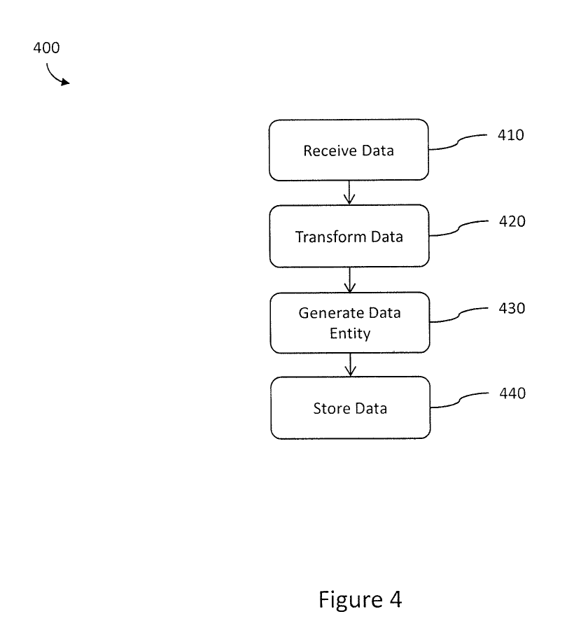

Referring now to FIG. 4, FIG. 4 shows a method for data integration and standardization according to one embodiment. The following disclosure related to the method shown in FIG. 4 will be described with respect to the system shown in FIG. 3, though it should be understood that the embodiments disclosed below may be performed using other systems or components based on this disclosure.

The method 400 of FIG. 4 begins in block 410 when data is received. In a clinical trial, various clinical trial sites record data at data providers, which then maintain data for a number of entities. These various entities tend to belong to a hierarchy. At the top of the hierarchy is the customer itself that is conducting a trial, which may refer to many trial entities. A trial will include a number of participating investigators. Each of the participating investigators will have a number of participating subjects. Each of subjects will participate in the trial by a number of visits to the investigator. And each of the visits will have associated data. However, data about some of these entities, (e.g. investigators, subjects, and visits) may be stored across several data stores at a particular location, referred to as source systems 310a-n, and there are typically many locations that participate in a single clinical trial.

In this embodiment, source systems 310a-n store a plurality of data records about one or more entities, wherein each of the data records comprises one or more data fields associated with the entity. For example data records representing a subject may include data fields such as subject ID, gender, and date of birth. When a new subject is added to a trial, or when data about a subject is recorded during a trial, one or more data records associated with the subject may be generated with information about the subject. To associate the data record with the subject, the data record includes data fields that, by itself or in concert with other data fields, uniquely identifies the subject, referred to herein as key data fields. After one or more data records for an entity are created at the source systems 310a-n, copies of the records are transmitted by the source systems 310a-n to the CRO, which receives the data records via a system interface 320. The system interface 320 then stores the data records in the staging database 330a-k.

In one embodiment, data records are received asynchronously from one or more of the source systems. For example, in one embodiment, one or more of the source systems 310a-n is configured to transmit one or more data records to the CRO once per day. In one such embodiment, the source system establishes a connection with the CRO via one or more system interfaces and initiates a transmission of one or more data records to the respective one or more system interfaces. In some embodiments, data may be received asynchronously at different rates or times, such as daily or weekly, or after a certain amount of data has been accumulated, or even immediately after a data record has been entered. In some embodiments, however, the data sources 310a-n do not push data to the CRO. Instead the CRO is configured to request data periodically from the data sources 310a-n. For example, in one embodiment the CRO transmits a request for new data records to the data sources 310a-n, which respond to the request by transmitting one or more data records to the CRO. When the CRO, at the system interfaces 320, receives the data records, the system interfaces 320 store the received data records in one or more staging databases 330 based on the type of data records received from the source systems 310a-n. After the CRO has received the data from the source systems 310a-n, the method proceeds to block 420.

In block 420, the CRO transforms the data from the formats of the various data sources into one or more common formats. In one embodiment, the data processing layer 340 retrieves one or more data records from the one or more staging databases 330a-k and transforms the data into data records having a common format for a particular type of data. For example, in one embodiment, the data processing layer retrieves one or more data records from a staging database having a first type and in a first data format. The data processing layer determines a common data format for the first type of data record and transforms data records from the first data format into the common data format for the first type of data record. If data records of the first type are received in multiple different formats, each first type of data record is transformed from its respective format in the staging database into the common data format for the first type of data.

For example, a plurality of data records representing lab results are received from a plurality of different source systems 310a-n. The various source systems 310a-n, in this embodiment, use different data record formats to store their lab results. Thus, the staging database (or databases) that store lab results stores the data records from the various source systems 310a-n in the format received from the source systems 310a-n. The data processing layer retrieves the lab result records from the staging database(s) in the respective different source system formats and transforms each of the lab result records into data records having a common data record format for lab results. The data records in the common data format are then stored in an operational database 350a-p configured to store such lab result data records in the common data format. The data processing layer 340 is further configured to perform such transformations on each of the data records stored in each of the staging databases 330a-k. After the data records have been transformed, the method proceeds to block 430.

At block 430, the data records in the common data formats are integrated into data entities. To integrate data records into data entities, the data integration layer 360 retrieves a first data record for an entity and determines the type of entity associated with the data record. Based on the type of data record, the data integration layer 360 determines the key field(s) associated with the entity. For example, the data integration layer 360 may determine that, if the data record represents a subject, the key data fields include a subject identification number, the subject's initials, gender, and a date of birth.

The data integration layer 360 analyzes the key data field(s) in the record to determine whether any records stored in the CRO integrated data store 370 have the same key data field(s). If no matching record is found in the CRO integrated data store 370, the data integration layer 360 creates a new record in the CRO integrated data store 370 using the information from the first received data record and flags the new record as a master record. However, if one or more matching records is found in the CRO integrated data store 370, the data integration layer 360 determines which of the matching records is a master record. The data integration layer 360 then associates the new data record with the master record and performs a data consistency analysis using at least the new data record and the master record.

To perform the data consistency analysis in this embodiment, the data integration layer 360 identifies one or more data fields associated with the entity for which data consistency should be checked and compares values for each of the one or more data fields in the new data record and the master record. If a data field does not exist in the new data record for which consistency is to be checked, the data integration layer 360 skips a consistency check for the data field. If a data field exists in both the new data record and the master record, the data integration layer 360 compares the two values for each data field in each record. The data integration layer 360 thus attempts to compare each of the data fields for which consistency should be checked.

If the data from each of the data field from the newly-received record matches the data in the corresponding data fields from the master record (e.g. both identify a subject's gender as female), the consistency check succeeds and the data integration layer 360 then proceeds to the next new data record. However, if data from a data field in the new data record does not match the corresponding data from the master record, the data integration layer 360 indicates an exception for the data field and proceeds with the remainder of the consistency check. Any additional exceptions are also flagged and reported. In this illustrative embodiment, the data integration layer 360 generates an email message having the identified exceptions and sends the email message to a user who may then to resolve the discrepancy. However, in some embodiments, other notifications may be generated, such as a log file or one or more visual or audible indicators. If, based on the user analysis, data in the master subject record is inaccurate, it is updated with the correct value. If the data in the newly-received record is inaccurate, it is updated with the correct value. Finally, if the newly-received record is a false match with the master record, the newly-received record is de-associated from the master record and the correct record is located, or a new master record is created using the newly-received record.

In this illustrative embodiment, the data integration layer 360 also performs data standardization for certain types of data records. If the data integration layer 360 determines that it has received a data record based on data entered from a subject trial visit form, the data integration layer 360 standardizes the data from the data record before storing it in the CRO integrated data store 370.

As is understood in the industry, when a clinical trial is constructed, various forms are constructed to gather data. During the trial, data is entered into the forms and subsequently stored into one or more of the various source systems 310a-n. However, forms used throughout the various locations during the trial may have different implementations, such as different formats for data entries or differently-named fields. Embodiments of systems and methods described herein address this problem.

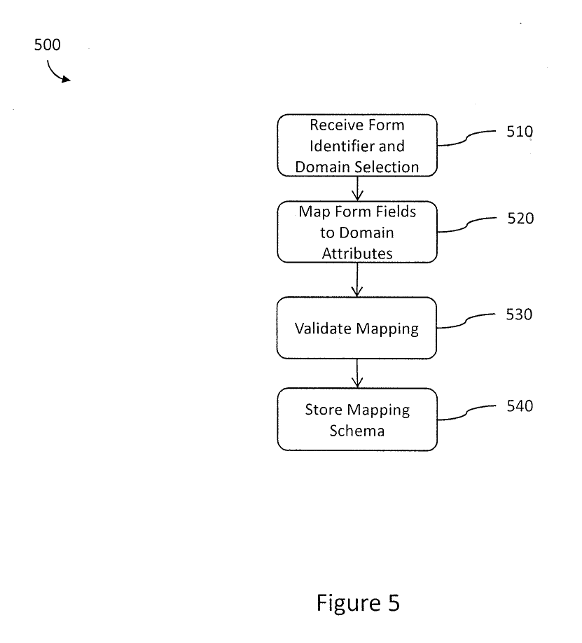

As was discussed previously, the data integration layer 360 may receive and employs a mapping schema 372 to transfer data from the operational databases 350a-p to one or more data entities within the CRO integrated data store 370. In one embodiment, a mapping tool 372 may be employed to create a mapping schema for use by the data integration layer. Methods for generating mapping schemas 374 are described in greater detail below with respect to FIG. 5. After data entities have been generated, the method 400 proceeds to block 440.

In block 440, the data integration layer 360 stores or updates one or more data entities within the CRO integrated data store 370. For example, as described above, if a new data entity is generated, after the new data entity has been generated and data has been integrated into the data entity, the data integration layer 360 transmits a command or signal to the CRO integrated data store 370 to cause the CRO integrated data store 370 to store the data entity. Or, if a data entity already exists and will be updated with newly-received data, the data integration layer 360 may transmit a command or signal to the CRO integrated data store 370 to cause the respective data entity to be updated with the newly-received data. After the data entity is stored, the method has completed.

It should be noted that the method shown in Figure may be repeated a large number of times and that multiple instances of the method may occur in parallel or even substantially simultaneously. For example, data received from various data sources 310a-n may be processed by a plurality of different systems within the CRO to execute embodiments of the method of FIG. 4. Further, different components within the system 300 may perform different portions of the method as was described above. Thus, after the data integration layer generates and stores a data entity, it may immediately begin processing another data entity using data from the operational databases 350a-p. Thus, the various blocks of the method 400 may occur asynchronously and it may not be necessary for one block to complete before another block begins.

Referring now to FIG. 5, FIG. 5 shows a method for generating a mapping schema 374 according to one embodiment. The following disclosure related to the method shown in FIG. 5 will be described with respect to the system shown in FIG. 3, though it should be understood that the embodiments disclosed below may be performed using other systems or components based on this disclosure.

In this illustrative embodiment, the mapping schema 374 comprises a spreadsheet in Microsoft Excel format. The mapping schema 374 may be generated using a mapping tool 372, such as Microsoft Excel, or another editor capable of creating a spreadsheet in Microsoft Excel format, such as OpenOffice. In other embodiments, the mapping schema 374 may be generated using other tools and may be stored in other formats, such as XML. The mapping schema 372 comprises information regarding data fields from forms used within the trial as well as information describing domains and variables within the CRO data store. In this illustrative embodiment, a domain corresponds to a table within a relational database, while a variable corresponds to a column within such a table.

The method 500 begins in block 510 when the mapping tool 372 receives a form identifier and a selection of a domain within the CRO integrated data store 370. In this embodiment, the selected domain is configured to store data associated with the form. In some embodiments, the selected domain may be configured to store some of the data associated with the form or data associated with a plurality of forms. The form identifier and the domain are then associated. After receiving the form identifier and the domain selection, the method proceeds to block 520.

In block 520, form fields are associated with attributes within the selected domain. For example, in one embodiment a form field associated with a subject's gender may be associated with an attribute in the selected domain corresponding to a subject's gender. Further, as noted previously, while a trial may have a specification for a form, database records representing forms may comprise data fields having significantly different names and data types. Thus, in addition to associating a form field with a domain attribute, data standardization information is determined as well. In some cases, multiple trials may use similar forms, thus providing potential for the reuse of mapping rules, discussed in more detail below. Thus, the mapping schema also includes information for standardizing form data into a common data record format for use within the CRO system. For example, in this illustrative embodiment, a source system may implement a data record for a form having a field for a subject's gender called “PT_GENDER” and the data field may be a numerical data field having three valid entries: 0, 1, 2 (corresponding to male, female, and unspecified). However, a second source system may implement a data record for a form having a field for a subject's gender called “P_GDR” and the field may be a text data field having three valid entries: “M,” “F,” and “U.” Thus, the mapping tool is capable of receiving identification values for form fields from one or more trial specifications, such as “Gender,” and then receiving field names corresponding to “Gender:” “P_GDR” and “PT_GENDER.” In addition, the mapping tool maintains data type information corresponding to the form field names and the domain variables. For example, a partial schema mapping according to one embodiment may have the following form for two source systems with different implementations of the same form specification:

### Illustrative Form to Domain Correspondence

| FORM | DOMAIN |
|---|---|
| VISIT1 | VISIT |
| VISITA | VISIT |

### Illustrative Visit1 Definition

### Form Implementation

FORM_VISIT1

| FIELD | NAME | TYPE |
|---|---|---|
| Gender | P_GDR | STR |
| Subject ID Number | P_NUM | STR |

### Illustrative VISITA Definition

### Form Implementation

FORM_VISITA

| FIELD | NAME | TYPE |
|---|---|---|
| Gender | PT_GENDER | INT |
| Subject ID Number | PT_INITIALS | STR |

### Illustrative VISIT Definition

### Domain

VISIT

| FIELD | VARIABLE | TYPE |
|---|---|---|
| Gender | P_GENDER | STR |
| Subject ID Number | P_ID | STR |

### Illustrative Form to Domain Mapping

| FIELD | NAME | VARIABLE | DATA_MAP |
|---|---|---|---|
| Gender | P_GDR | P_GENDER | “M” = “MALE” |
| | | | “F” = “FEMALE” |
| | | | “U” = “UNSPEC” |
| Gender | PT_GENDER | P_GENDER | 0 = “MALE” |
| | | | 1 = “FEMALE” |
| | | | 2 = “UNSPEC” |

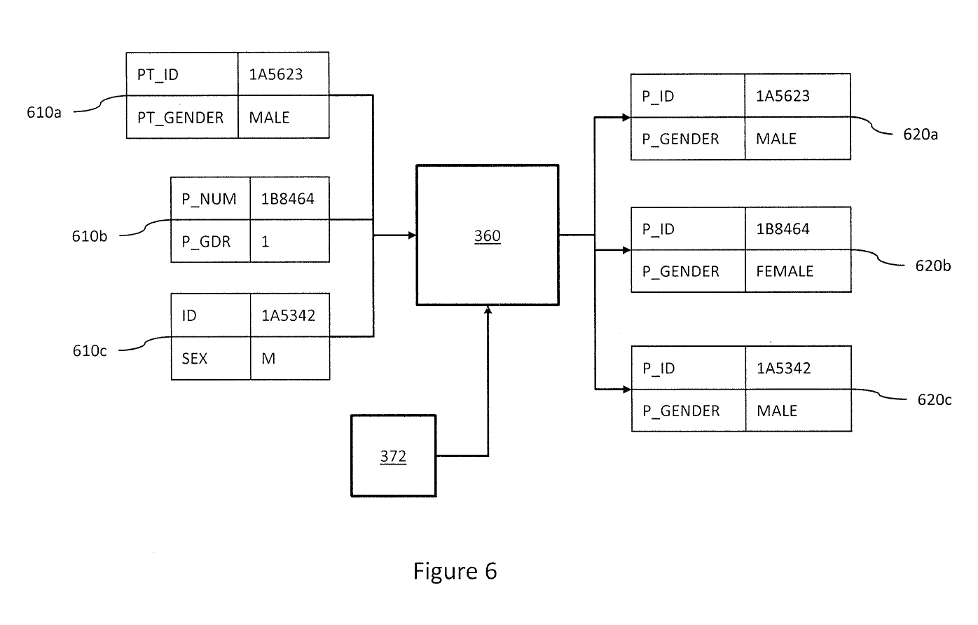

Thus, in this embodiment the mapping tool may be employed to generate an association between form fields and domain attributes that includes data standardization information. As may be seen in the embodiment shown in FIG. 6, a mapping schema 372 may be employed by the integration layer 360 to access records 610a-c stored according to different formats and store the data in records 620a-c according to a common format. For example, in one embodiment, the mapping tool may be configured to provide data standardization information to be used by the data integration layer for providing uniform data values for a particular form field within the CRO integrated data store 370.

In addition to receiving information to map form fields to domain attributes, some such mappings may be automatically determined based on previously-existing mapping schemas. For example, many mappings may be common throughout various trials, such as subject initials, genders, dates of birth, etc. In many cases, field names may be similar or the same throughout different trials. And while trials may use different form specifications, previously-generated rules may be applicable across a wide variety of clinical trials, such as subject information, blood test results, etc. Thus, based on a domain and a corresponding form specification, one embodiment is configured to identify existing rules that provide mapping definitions between form fields and domain variables.

And while different form implementations may employ different data fields, in some embodiments, at least a portion of a rule for mapping to a domain may be reusable or the tool may suggest a newly-generated rule. For example, in the embodiment shown above, a form implementation for a second clinical trial may include a field for a subject's gender named PT_GDR and may map to a domain similar to the domain used in the first trial. Thus, the tool may identify ‘PT_GDR’ as likely corresponding to a subject gender field, such as by a fuzzy match algorithm configured to search for similar fields in existing rules within the CRO data store. Based on a form to domain correspondence, the tool may then identify a variable within the corresponding domain that is similar to gender and generate a suggested rule and present the suggested rule for inclusion within the mapping schema. Thus, a mapping tool 372 according to the present disclosure may be capable, by using rule reuse and rule suggestion, of significantly reducing the time to generate a mapping schema for a new clinical trial. After form fields have been associated with domain attributes, the method proceeds to block 530.

In block 530, the mapping tool 372 validates the mapping information. For example, in the embodiment described above, the mapping tool 372 is configured to validate rules in a mapping schema. For example, a user may use the mapping tool 372 to generate a mapping schema between a form and a domain. However, while generating the mapping schema, the user may enter invalid information, such as an invalid form field name or an invalid data type. Thus, the mapping tool 372 is configured to parse schema mapping rules to identify invalid entries. For example, if a form definition includes a field entitled PT_GENDER, but a mapping rule is generated that identifies field P_GENDER, the mapping tool 372 will identify the P_GENDER as an invalid form field. Thus, mapping schema generation may be more robust and may prevent runtime errors within the data integration layer by catching and correcting within the mapping schema prior to introduction into a live system. After the mapping has been validated, the method 500 proceeds to block 540.

In block 540, the mapping schema 374 is stored. In this embodiment, the mapping schema 374 is provided to the data integration layer 360, which may then use the mapping schema 374 to perform data integration and standardization. In this embodiment, the mapping tool 372 is also configured to store the mapping schema 374 or rules from the mapping schema 374 within the CRO integrated data store 370 for reuse in other trials.

The use of a mapping schema may allow a CRO more efficiently ingest and process data into a form that is readily usable by one or more applications. For example, because the data integration layer according to some embodiments is configured to perform data integration and standardization based on a schema mapping, the development of data ingestion functionality may be significantly accelerated, which may allow for real-time or near-real-time capture of data from source systems. This may allow a company running a trial to develop interim results or identify potential issues during the trial, rather than after the fact as is the case in convention systems.

### General

While the methods and systems herein are described in terms of software executing on various machines, the methods and systems may also be implemented as specifically-configured hardware, such a field-programmable gate array (FPGA) specifically to execute the various methods. For example, embodiments can be implemented in digital electronic circuitry, or in computer hardware, firmware, software, or in a combination of thereof. In one embodiment, a system for data integration and standardization may comprise a processor or processors. The processor(s) are configured to execute computer-executable program instructions stored in memory, such as executing one or more computer programs for data integration and standardization. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable media, that may store instructions that, when executed by the processor, can cause the processor to perform the steps described herein as carried out, or assisted, by a processor. Embodiments of computer-readable media may comprise, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some embodiments have been presented only for the purpose of illustration and description and is not intended to be exhaustive or to limit the invention to the precise forms disclosed. Numerous modifications and adaptations thereof will be apparent to those skilled in the art without departing from the spirit and scope of the invention.

Reference herein to “one embodiment” or “an embodiment” means that a particular feature, structure, operation, or other characteristic described in connection with the embodiment may be included in at least one implementation of the invention. Of course, that particular feature, structure, operation, or other characteristic may not be included in other implementations of the invention. The invention is not restricted to the particular embodiments described as such. The appearance of the phrase “in one embodiment” or “in an embodiment” in various places in the specification does not necessarily refer to the same embodiment. Any particular feature, structure, operation, or other characteristic described in this specification in relation to “one embodiment” may be combined with other features, structures, operations, or other characteristics described in respect of any other embodiment.

That which is claimed is:

1. A method comprising:
receiving first clinical trial data from a first data store, the first clinical trial data stored in a first format and comprising a plurality of data records;
receiving second clinical trial data from a second data store, the second data store different from the first data store, the second clinical trial data stored in a second format, the second format different from the first format and comprising a plurality of data records;
transforming the first clinical trial data from the first format to a first operational data format and storing the first clinical trial data in the first operational data format in a first operational data store;
transforming the second clinical trial data from the second format to a second operational data format and storing the second clinical trial data in the second operational data format in a second operational data store;
generating a first data entity stored in an integrated data format in an integrated data store;
selecting a first data record from first clinical trial data in the first operational data format;
identifying a second data record from the second clinical trial data in the second operational data format, wherein identifying the second data record is based at least in part on a determined association between the first data record and the second data record; and
storing data from the first data record and the second data record in the first data entity.

2. The method of claim 1, further comprising:
receiving the first remote clinical trial data from a first remote data store, the first remote clinical trial data stored in a first remote format;
receiving the second remote clinical trial data from a second remote data store, the second remote clinical trial data stored in a second remote format;
transforming the first remote clinical trial data from the first remote format to the first clinical trial data in the first format; and
transforming the second remote clinical trial data from the second remote format to the second clinical trial data in the second format.

3. The method of claim 2, wherein at least one of the first remote clinical trial data or the second remote clinical trial data is received in real-time.

4. The method of claim 1, wherein the receiving of the first and second clinical trial data occurs in real-time.

5. The method of claim 4, wherein the steps of transforming the first and second clinical trial data, generating the first data entity, selecting the first data record, identifying the second data record, and storing data occurs in real-time after receiving the first and second clinical trial data.

6. The method of claim 1, further comprising receiving a mapping specification, and wherein identifying the second data record is further based at least in part on the mapping specification.

7. The method of claim 6, wherein storing data from the first data record and the second data record in the first data entity comprises converting at least some of the data from the first data record and the second data record into the integrated data format based at least in part on the mapping specification.

8. The method of claim 1, wherein generating the first entity comprises identifying an existing entity in the integrated data store.

9. A computer-readable medium comprising program code for causing a processor to execute a method, the program code comprising:
program code for receiving first clinical trial data from a first data store, the first clinical trial data stored in a first format and comprising a plurality of data records;
program code for receiving second clinical trial data from a second data store, the second data store different from the first data store, the second clinical trial data stored in a second format, the second format different from the first format and comprising a plurality of data records;
program code for transforming the first clinical trial data from the first format to a first operational data format and storing the first clinical trial data in the first operational data format in a first operational data store;
program code for transforming the second clinical trial data from the second format to a second operational data format and storing the second clinical trial data in the second operational data format in a second operational data store;
program code for generating a first data entity stored in an integrated data format in an integrated data store;
program code for selecting a first data record from first clinical trial data in the first operational data format;
program code for identifying a second data record from the second clinical trial data in the second operational data format, wherein identifying the second data record is based at least in part on a determined association between the first data record and the second data record; and
program code for storing data from the first data record and the second data record in the first data entity.

10. The computer-readable medium of claim 9, further comprising:
program code for receiving the first remote clinical trial data from a first remote data store, the first remote clinical trial data stored in a first remote format;
program code for receiving the second remote clinical trial data from a second remote data store, the second remote clinical trial data stored in a second remote format;
program code for transforming the first remote clinical trial data from the first remote format to the first clinical trial data in the first format; and
program code for transforming the second remote clinical trial data from the second remote format to the second clinical trial data in the second format.

11. The computer-readable medium of claim 10, wherein at least one of the first remote clinical trial data or the second remote clinical trial data is received in real-time.

12. The computer-readable medium of claim 9, wherein the receiving of the first and second clinical trial data occurs in real-time.

13. The computer-readable medium of claim 12, wherein the steps of transforming the first and second clinical trial data, generating the first data entity, selecting the first data record, identifying the second data record, and storing data occurs in real-time after receiving the first and second clinical trial data.

14. The computer-readable medium of claim 9, further comprising program code for receiving a mapping specification, and wherein the program code for identifying the second data record is further based at least in part on the mapping specification.

15. The computer-readable medium of claim 14, further comprising a mapping tool, the mapping tool configured to generate the mapping specification.

16. The computer-readable medium of claim 14, wherein the program code for storing data from the first data record and the second data record in the first data entity comprises program code for converting at least some of the data from the first data record and the second data record into the integrated data format based at least in part on the mapping specification.

17. The computer-readable medium of claim 9, wherein the program code for generating the first entity comprises program code for identifying an existing entity in the integrated data store.

18. A system comprising:
a system interface comprising at least one processor in communication with a computer readable medium, the system interface configured to receive data from one or more source systems;
at least one staging database, the staging database comprising a computer readable medium configured to store one or more data records according to data formats of the one or more source systems;
a data processing layer comprising at least one processor in communication with a computer readable medium, the data processing layer configured to receive the one or more data records from the at least one staging database and to transform the one or more data records into one or more operational data formats;
at least one operational database, the staging database comprising a computer readable medium configured to store one or more data records according to the one or more operational data formats;
a data integration layer comprising at least one processor in communication with a computer readable medium, the data integration layer configured to receive the one or more data records from the at least one operational database and to generate or update one or more data entities based on the one or more data records from the at least one operational database; and
an integrated data store, the integrated data store configured to receive and store the one or more data entities from the data integration layer.

19. The system of claim 18, wherein the data integration layer is further configured to receive at least one mapping schema, and to generate the one or more data entities based at least in part on the at least one mapping schema.

20. The system of claim 18, wherein the integrated data store is further configured to receive and store at least one mapping schema.
